(19) United States
(12) Patent Application Publication
(10) Pub. No.: US 2005/0073918 A1
(43) Pub. Date: Apr. 7, 2005

(54) Optical disc apparatus and tracking control method and program for the optical disc apparatus

(76) Inventors: Ryoichi Ishikawa, Kyoto-shi (JP); Takayuki Ohta, Kyoto-shi (JP); Hirofumi Inoue, Osaka (JP)

Correspondence Address: MCDERMOTT WILL & EMERY LLP, 600 13TH STREET, N.W., WASHINGTON, DC, 20005-3096, US

(21) Appl. No.: 10/954,353

(22) Filed: Oct. 1, 2004

(30) Foreign Application Priority Data
Oct. 1, 2003 (JP) JP2003-343016

(51) Int. Cl. G11B 7/00

(52) U.S. Cl. 369/44.25; 369/44.34; 369/44.29

(57) ABSTRACT

An optical disc apparatus for performing tracking control based on TE and OFT signals even with such low-quality optical discs that do not meet the standards on track-to-track distance. A signal generating unit generates a TE signal and also generates an OFT signal from an input RF signal based on a first threshold value. A duty ratio calculating unit calculates a duty ratio, a ratio of the H signals to the OFT signal in length, by measuring the time of the H signals in the OFT signal. A threshold value changing unit changes the threshold value from the first value to the second value if the duty ratio does not fall within a predetermined range. A tracking control unit controls the driving unit in accordance with the TE signal and the OFT signal when the duty ratio falls within the predetermined range.

### BACKGROUND OF THE INVENTION

(1) Field of the Invention

The present invention relates to an optical disc apparatus such as a CD player, and more specifically to an optical disc apparatus that performs a tracking control using an offtrack signal generated from a radio frequency signal that a pickup detects.

(2) Description of the Related Art

On the information recording surface of optical discs, concentric or spiral tracks are formed, and information is recorded in the pits formed in the tracks.

Optical disc apparatuses require tracking control to lead the pickup emitting a laser beam to a desired track, for information recording or reproduction.

There are conventional tracking control methods in which the tracking error (TE) signal and offtrack (OFT) signal are used. The TE signal indicates a distance between a track and a focal point of a laser beam emitted from the pickup. The OFT signal is a binarized signal. The OFT signal is generated from a RF (Radio Frequency) signal that is detected by the pickup. The OFT signal is L signal when the pickup is on track, and is H signal when the pickup is off track. The optical disc apparatuses detect the position of the pickup by analyzing the TE signal and OFT signal, and move the pickup onto a target track.

Meanwhile, a track-to-track distance for each type of optical disc is defined by standards. For example, the track-to-track distance of CD is defined as 1.6 μm. With CDs meeting the standards on track-to-track distance, the L and H signals of the generated OFT signals indicate correctly whether the pickup is on track or off track. However, with low-quality CDs not meeting the standards on track-to-track distance (for example, CDs having 1.4 μm of track-to-track distance) or having a low disc surface reflection accuracy, the generated OFT signal, for example, may be the H signal even when the pickup is on track.

Such low-quality CDs make it difficult for optical disc apparatuses to detect a correct pickup position by analyzing the TE and OFT signals. This makes it impossible to perform the tracking control.

### SUMMARY OF THE INVENTION

The object of the present invention is therefore to provide an optical disc apparatus and a tracking control method for use in an optical disc apparatus, for performing the tracking control with accuracy based on the TE and OFT signals even with such low-quality optical discs that do not meet the standards on track-to-track distance or have a low reflection accuracy.

The above object is fulfilled by an optical disc apparatus comprising: a pickup operable to emit a laser beam toward an optical disc and detect a read signal from a reflected laser beam; a driving unit operable to drive the pickup radially above the optical disc; a tracking error signal generating unit operable to generate a tracking error signal that indicates a distance between a track in which information is recorded and a focal point of the emitted laser beam; an offtrack signal generating unit operable to generate an offtrack signal from the detected read signal based on a threshold value, the offtrack signal being a binarized signal composed of H signals and L signals; a threshold value changing unit operable to, when a duty ratio, which is a ratio of the H signals to the offtrack signal in length, does not fall within a predetermined range, change the threshold value from a first value to a second value so as to correct the duty ratio; and a tracking control unit operable to control the driving unit in accordance with the tracking error signal and the offtrack signal.

The above-stated construction secures generation of such a offtrack signal including H signals indicating that the pickup is off track that allows the duty ratio thereof to fall within the predetermined range. This enables the tracking control unit to detect the position of the pickup by analyzing the tracking error signal and the offtrack signal, and control the driving unit to move the pickup onto a desired track. This secures the reproduction or recording of the optical discs.

In the above-described optical disc apparatus, the threshold value changing unit may include: an H signal measuring sub-unit operable to measure time of H signals of the offtrack signal for a predetermined time period, and add up the measured time; an L signal measuring sub-unit operable to measure time of L signals of the offtrack signal for the predetermined time period, and add up the measured time; and a duty ratio calculating sub-unit operable to calculate a duty ratio by dividing a summation time of the H signals measured in the predetermined time period by a summation time of the H signals and the L signals measured in the predetermined time period.

With the above-stated construction, it is possible to calculate the duty ratio, making it easy to judge whether to change the threshold value.

In the above-described optical disc apparatus, the predetermined time period may correspond to a time period during which a predetermined frequency is detected in the tracking error signal.

The above-stated construction increases the reliability of the obtained duty ratio.

In the above-described optical disc apparatus, the threshold value changing unit may further include: a pulse generating sub-unit operable to generate pulse signals which are each shorter than each H signal or L signal in the offtrack signal, wherein the H signal measuring sub-unit and the L signal measuring sub-unit count the number of pulses generated by the pulse generating sub-unit for each duration of H signals and L signals, for the measuring of the time of H signals and L signals, respectively.

With the above-stated construction, it is possible to obtain accurate duty ratio values by calculation.

In the above-described optical disc apparatus, the predetermined range of the duty ratio may be a range from 45% to 55%, and the first value of the threshold value is determined for each type of optical disc by preparing a predetermined number of optical discs meeting standards for each type, measuring duty ratio values of each of the optical discs based on various threshold values, selecting, among the various threshold values, a threshold value with which each of the duty ratio values is approximately 50%, and determining the selected threshold value as the first value of the threshold value.

The above-stated construction, in which the first value of the threshold value is determined so that each duty ratio value is approximately 50%, enables the duty ratio to fall within the predetermined range when the optical disc apparatus performs reproduction or recording of an optical disc that meets the standards on track-to-track distance.

In the above-described optical disc apparatus, the threshold value changing unit may include: a threshold value changing table storage sub-unit operable to store a threshold value changing table that indicates a plurality of second values of the threshold value corresponding to a plurality of ranges of duty ratio for each type of optical disc to which the first value of the threshold value is assigned uniquely, and when a duty ratio value obtained based on the first value of the threshold value does not fall within the predetermined range, the threshold value changing unit changes the threshold value from the first value to a corresponding one of the plurality of second values as indicated in the threshold value changing table.

The above-stated construction expedites the changing of the threshold value, securing that the obtained duty ratio falls within the predetermined range.

In the above-described optical disc apparatus, the threshold value changing unit may include an amount value storage sub-unit operable to store an amount value that is to be added to or subtracted from the threshold value, and when the duty ratio is lower than the predetermined range, the threshold value changing unit subtracts the amount value from the threshold value in sequence until the duty ratio falls within the predetermined range, and when the duty ratio is higher than the predetermined range, the threshold value changing unit adds the amount value to the threshold value in sequence until the duty ratio falls within the predetermined range, and sets the second value of the threshold value to a threshold value with which the duty ratio falls within the predetermined range.

The above-stated construction secures that the threshold value is changed so as to correct the duty ratio.

In the above-described optical disc apparatus, the threshold value changing unit may include: a threshold value changing equation storage sub-unit operable to store therein an equation: the second value of the threshold value=
k×(the duty ratio−50)+the first value of the threshold value (1)
wherein “k” represents a parameter uniquely allocated to each type of optical disc, and the threshold value changing unit calculates the second value of the threshold value in accordance with the equation (1).

With the above-stated construction, it is possible to deal with various types of optical discs and change the threshold value with ease.

The above object is also fulfilled by a tracking control method for an optical disc apparatus, the tracking control method comprising the steps of: emitting a laser beam toward an optical disc and detecting a read signal from a reflected laser beam; driving the pickup radially above the optical disc; generating a tracking error signal that indicates a distance between a track in which information is recorded and a focal point of the emitted laser beam; generating an offtrack signal from the detected read signal based on a threshold value, the offtrack signal being a binarized signal composed of H signals and L signals; changing, when a duty ratio, which is a ratio of the H signals to the offtrack signal in length, does not fall within a predetermined range, the threshold value from a first value to a second value so as to correct the duty ratio; and controlling the driving unit in accordance with the tracking error signal and the offtrack signal.

The above-stated construction secures generation of such a offtrack signal including H signals indicating that the pickup is off track that allows the duty ratio thereof to fall within the predetermined range. This enables the tracking control unit to detect the position of the pickup by analyzing the tracking error signal and the offtrack signal, and control the driving unit to move the pickup onto a desired track. This secures the reproduction or recording of the optical discs.

The above object is also fulfilled by a tracking control program that causes an optical disc apparatus to execute the steps of: emitting a laser beam toward an optical disc and detecting a read signal from a reflected laser beam; driving the pickup radially above the optical disc; generating a tracking error signal that indicates a distance between a track in which information is recorded and a focal point of the emitted laser beam; generating an offtrack signal from the detected read signal based on a threshold value, the offtrack signal being a binarized signal composed of H signals and L signals; changing, when a duty ratio, which is a ratio of the H signals to the offtrack signal in length, does not fall within a predetermined range, the threshold value from a first value to a second value so as to correct the duty ratio; and controlling the driving unit in accordance with the tracking error signal and the offtrack signal.

By applying the above-stated tracking control program to the optical disc apparatus, it is possible to perform the tracking control with reliability for reproduction or recording of optical discs even if they do not meet standards.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows the structure of the optical disc apparatus in Embodiment 1 of the present invention;

FIG. 2 shows a TE signal and an OFT signal generated by the signal generating unit with a CD-DA meeting the standards;

FIG. 3 illustrates a process of generating the OFT signal shown in FIG. 2;

FIG. 4 shows a TE signal and an OFT signal generated by the signal generating unit with a CD-DA that does not meet the standards, based on the initially-set first threshold value.

FIG. 5 shows an example of an OFT signal which was changed from the OFT signal shown in FIG. 4 by generating it based on the second threshold value instead of the first threshold value;

FIG. 6 shows another example of the OFT signal generated based on the second threshold value instead of the first threshold value;

FIG. 7 shows the tracking drive signal that is input into the driving unit to obtain a duty ratio value that falls within the predetermined range;

FIG. 8 shows an example of the threshold value changing table that is stored in the threshold value changing unit; and

FIG. 9 is a flowchart of the operation procedure of the optical disc apparatus in the embodiment of the present invention.

### DESCRIPTION OF THE PREFERRED EMBODIMENT

The following describes an optical disc apparatus as a preferred embodiment of the present invention, with reference to the attached drawings.

### Embodiment 1

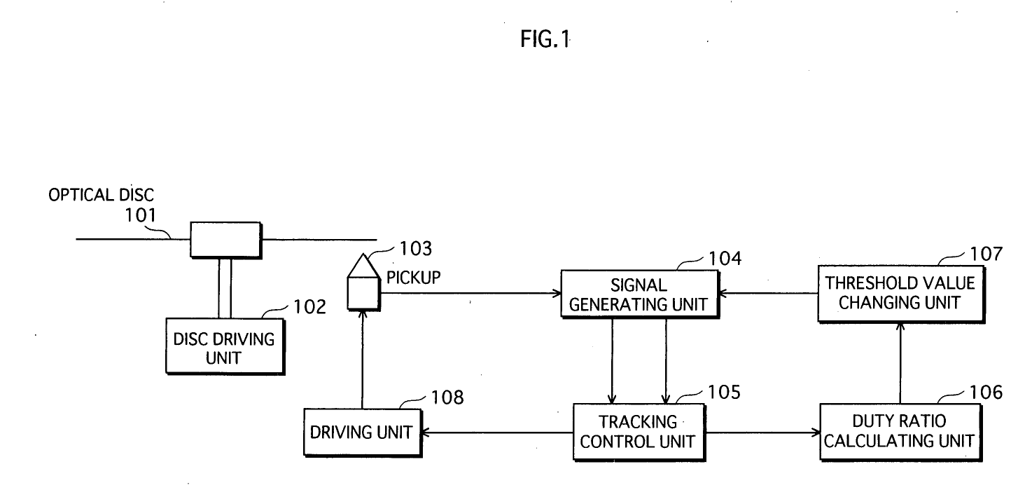

FIG. 1 shows the structure of the optical disc apparatus in Embodiment 1 of the present invention.

As shown in FIG. 1, the optical disc apparatus includes a disc driving unit 102, a pickup 103, a signal generating unit 104, a tracking control unit 105, a duty ratio calculating unit 106, a threshold value changing unit 107, and a driving unit 108. An optical disc 101 is attached to and detached from the optical disc apparatus.

The optical disc 101 is such a disc as CD-ROM, CD-R, CD-RW, DVD-RAM, DVD-RW, and PD for which laser light is used to read information from the disc.

The disc driving unit 102 is achieved by a spindle motor. If the optical disc 101 is a CD, the disc driving unit 102 controls the rotation of the disc to maintain a constant linear velocity. This is based on a method called CLV (Constant Linear Velocity) in which the disc rotation speed is made slower when the pickup 103 is near the periphery of the disc than when the pickup 103 is near the center of the disc. When the optical disc 101 is a DVD-RAM, the disc rotation is controlled by a method called ZCLV (Zone Constant Linear Velocity) in which the disc rotation speed is changed for each zone in which the pickup 103 is located.

The pickup 103 emits a laser beam toward the information recording surface of the optical disc 101, reads a RF (Radio Frequency) signal from the light reflected from the optical disc 101, and outputs the read RF signal to the signal generating unit 104. The pickup 103 includes a 2-split photodiode that receives light reflected and diffracted by grooves formed in the optical disc, divides the received light into two signals, and outputs the two signals to the signal generating unit 104.

The signal generating unit 104 generates an OFT signal from the RF signal input from the pickup 103, and also generates a TE signal from the two signals of the reflected/diffracted light input from the pickup 103.

The signal generating unit 104 generates the OFT signal by converting the RF signal into H signals and L signals based on a threshold value that is set in advance. A different threshold value is set for each type, such as CD-DA, CD-RW, or DVD-RAM, of the optical disc 101.

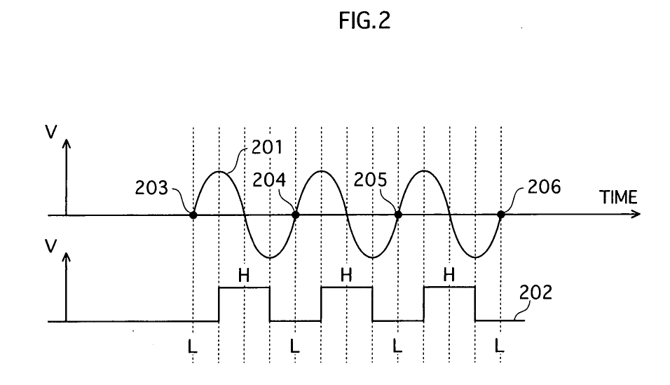

FIG. 2 shows an example of a TE signal 201 and an OFT signal 202 generated by the signal generating unit 104 as the pickup 103 moves radially above the optical disc 101. The optical disc 101 here is a CD-DA with 1.6 μm of track-to-track distance meeting the standards.

The signal generating unit 104 generates the TE signal 201 according to the difference between the two signals output from the 2-split photodiode of the pickup 103. The TE signal 201 indicates a difference between the laser light emission position of the pickup 103 and a track in which information is recorded. Points 203, 204, 205, and 206 shown in FIG. 2, where the TE signal 201 changes from minus to plus, are called zero cross points and indicate that the laser light emission position of the pickup 103 (hereinafter referred to as position of the pickup 103) is on a track.

The signal generating unit 104 converts the RF signal input from the pickup 103 into the OFT signal 202 based on a first threshold value that is set in advance. The L signal of the OFT signal 202 indicates that the pickup is on track, and the H signal indicates that the pickup is offtrack.

The signal generating unit 104, which is composed a tracking error signal generating unit and an offtrack signal generating unit, generates and outputs the TE signal and the OFT signal to the tracking control unit 105.

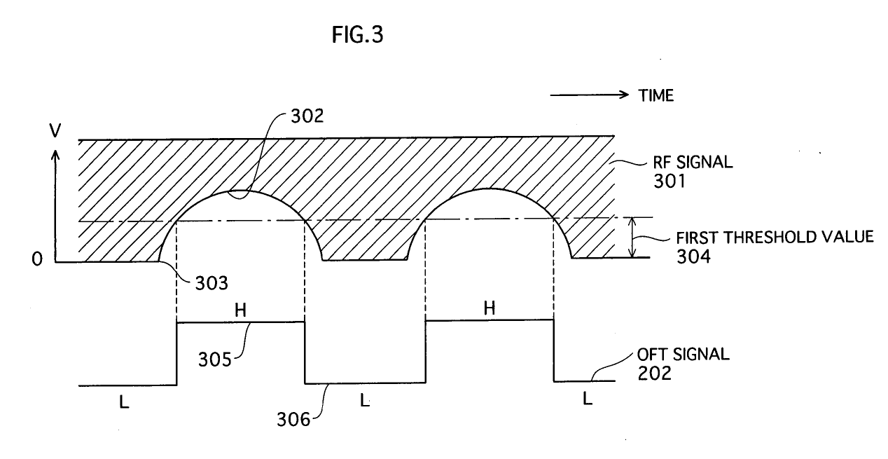

Here, how the OFT signal 202 is generated will be explained with reference to FIG. 3.

The signal generating unit 104 receives a RF signal 301 from the pickup 103. As shown in FIG. 3, at the start 303 of the concave 302 in the RF signal 301 when the pickup 103 is offtrack, the voltage V is 0.

The signal generating unit 104 stores in advance a first threshold value that is different for each disc type. Upon receiving a notification of a disc type from a control unit (not illustrated), the signal generating unit 104 converts the RF signal 301, based on the first threshold value 304, into a binarized signal composed of the H signals 305 and the L signals 306. More specifically, a portion of the RF signal 301 having a voltage not lower than the first threshold value 304 is converted into the H signal 305, and a portion of the RF signal 301 having a voltage lower than the first threshold value 304 is converted into the L signal 306. In this way, the OFT signal 202 composed of the H signals 305 and the L signals 306 is generated.

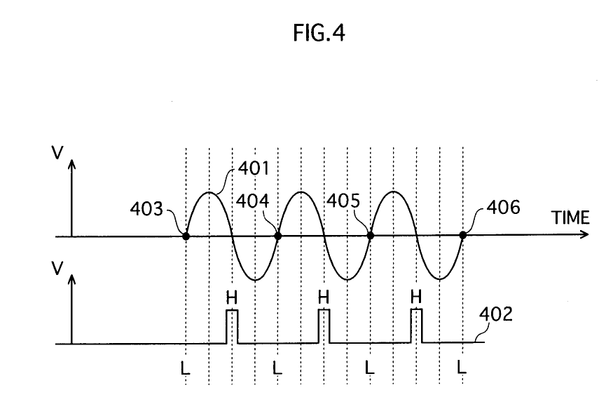

FIG. 4 shows another example of a TE signal 401 and an OFT signal 402 generated by the signal generating unit 104. The optical disc used in the example is low-quality having 1.4 μm of the track-to-track distance that does not meet the standards.

In the OFT signal 402, the H signals are shorter than the L signals. In other words, the duty ratio does not fall within a predetermined range of values.

In such a case, the signal generating unit 104 is instructed by the threshold value changing unit 107 to change the threshold value to the second threshold value.

The signal generating unit 104 then generates the OFT signal from the RF signal based on the second threshold value.

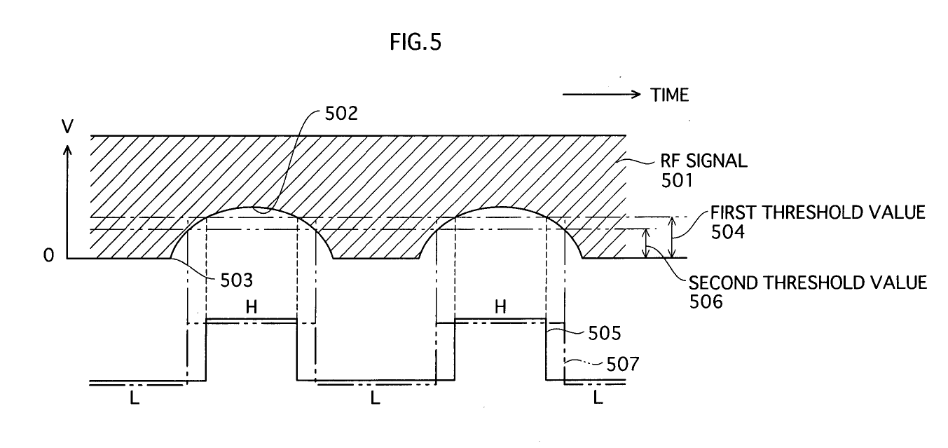

Now, how the threshold value is changed will be described with reference to FIG. 5.

The signal generating unit 104 receives a RF signal 501 from the pickup 103. The concave 502 in the RF signal 501 is smaller than the concave 302 in the RF signal 301. At the start 503 of the concave 502, the voltage V is 0. The signal generating unit 104 converts a portion of the RF signal 501 having a voltage not lower than the first threshold value 504 into the H signal, and converts a portion of the RF signal 501 having a voltage lower than the first threshold value 504 into the L signal. In this way, the OFT signal 505, which is indicated by the solid line in FIG. 5, is generated.

When instructed by the threshold value changing unit 107 to change the threshold value to the second threshold value 506, the signal generating unit 104 converts a portion of the RF signal 501 having a voltage not lower than the second threshold value 506 into the H signal, and converts a portion of the RF signal 501 having a voltage lower than the second threshold value 506 into the L signal. In this way, the OFT signal 507, which is indicated by the chain double-dashed line in FIG. 5, is generated. The signal generating unit 104 outputs the generated OFT signal 507 to the tracking control unit 105.

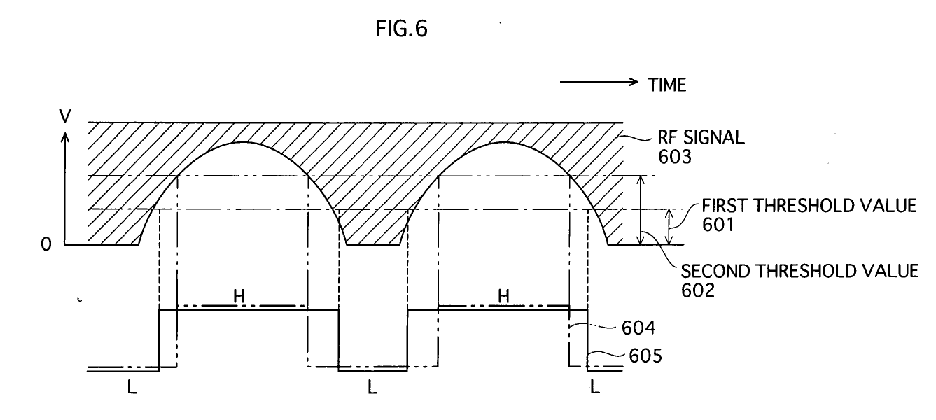

FIG. 6 shows another example of the OFT signal generated by the signal generating unit 104 based on the first threshold value, where the H signals are longer than the L signals. In such a case, the signal generating unit 104 is instructed by the threshold value changing unit 107 to change the threshold value from the first threshold value 601 to the second threshold value 602 that is larger than the first threshold value 601.

The signal generating unit 104 then generates the OFT signal 604, which is indicated by the chain double-dashed line in FIG. 6, from the RF signal 603 based on the second threshold value 602. The OFT signal 604 has shorter H signals than the OFT signal 605 indicated by the solid line in FIG. 6, which was generated before the OFT signal 604.

Upon receiving from the control unit (not illustrated) a notification that an optical disc was inserted into the optical disc apparatus, the tracking control unit 105 outputs a tracking drive signal to the driving unit 108.

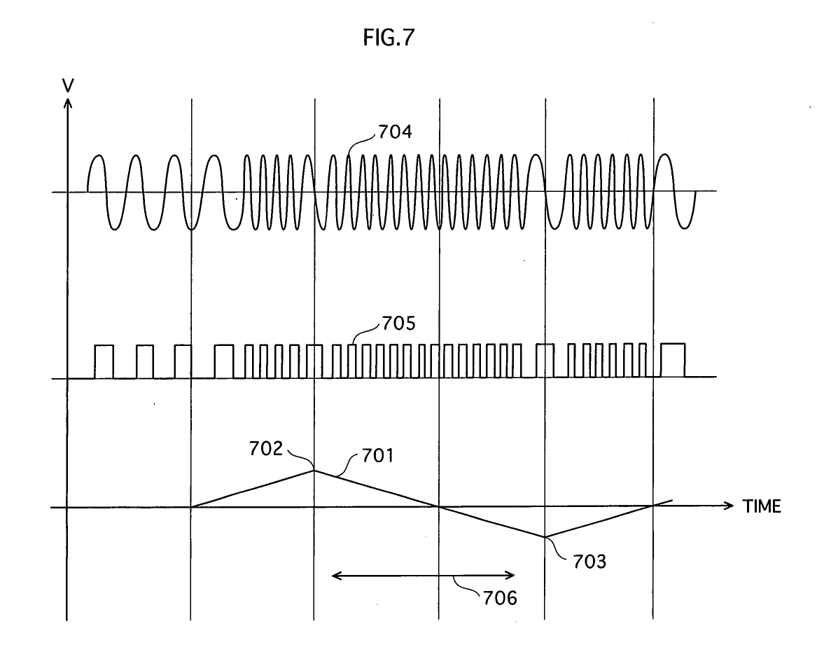

FIG. 7 shows the tracking drive signal, TE signal, and OFT signal. The tracking drive signal 701 is a voltage signal having, for example, triangular waveform. The driving unit 108 moves the pickup 103 radially above the optical disc 101 according to the tracking drive signal.

The apexes 702 and 703 of triangular waves correspond to the events of inverting the moving direction of the pickup 103. As a result, in the vicinities of the apexes 702 and 703, the frequency of the TE signal 704 is not constant, and the H or L signals of the OFT signal 705 change in length. Therefore, if the duty ratio is calculated using the portions near the apexes 702 and 703 of triangular waves, factors other than those changing the duty ratio enter the calculation result.

For this reason, the tracking control unit 105 instructs the duty ratio calculating unit 106 to calculate a duty ratio for a portion 706 that does not include vicinities of the apexes 702 and 703 of triangular waves. That is to say, the tracking control unit 105 outputs a portion of the OFT signal 705 that corresponds to the portion 706 of the tracking drive signal 701, to the duty ratio calculating unit 106.

The tracking control unit 105, through analysis during reproduction or recording of the optical disc 103, judges that the pickup 103, moving radially above the optical disc, is currently in the middle of a track if (i) the TE signal changes from minus to plus and (ii) the OFT signal is the L signal. The tracking control unit 105 then outputs a tracking drive signal to the driving unit 108 so as to cause the pickup 103 to move to a target track.

Meanwhile, it is difficult for the tracking control unit 105 to correctly judge the position of the pickup 103 if the duty ratio of the OFT signal does not fall within a predetermined range of values. In such a case, the tracking control unit 105 needs to wait until it receives an OFT signal for which the duty ratio falls within the predetermined range of values, then judges the position of the pickup 103, and then outputs a tracking drive signal to the driving unit 108.

The duty ratio calculating unit 106 constitutes a part of the threshold value changing unit 107, and includes a timer. Upon receiving the OFT signal from the signal generating unit 104 via the tracking control unit 105, the duty ratio calculating unit 106 measures the time of each H signal and L signal for a predetermined time period. After the predetermined time period, the duty ratio calculating unit 106 calculates the duty ratio D based on the following equation:
D=Ht/(Ht+Lt)×100
where “Ht” represents an accumulated time of the H signal portions, and “Lt” represents an accumulated time of the L signal portions.

The duty ratio calculating unit 106 sends the calculated value of the duty ratio D to the threshold value changing unit 107.

The predetermined time period referred to in the above description may be a time period taken for the pickup to cross a certain number of tracks, for example, 8192 tracks, which is indicated by the TE signal. In other words, the predetermined time period may be a time period that is long enough to give reliability to the calculated duty ratio.

In the present embodiment, a timer is used. However, the timer may not necessarily be used. That is to say, the optical disc apparatus may be provided with a pulse signal generating unit that generates pulse signals which are each well shorter than each H signal or L signal of the OFT signal, counts the pulse signals generated during each portion of the H and L signals, and calculates the duty ratio D based on the following equation:
D=Hc/(Hc+Lc)×100
where “Hc” represents the accumulated number of pulse signals in the H signal portions, and “Lc” represents the accumulated number of pulse signals in the L signal portions.

The threshold value changing unit 107 stores a threshold value changing table in a storage area.

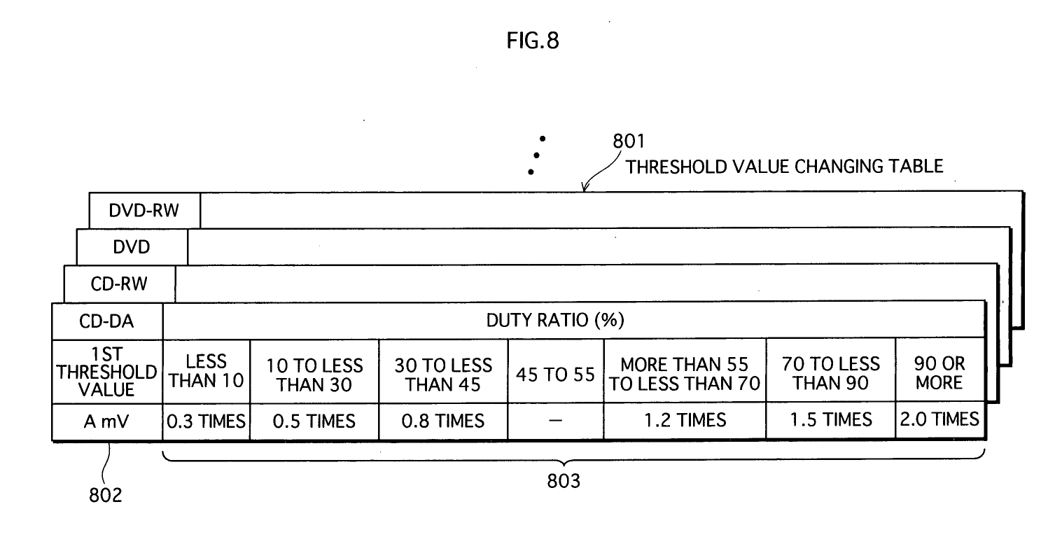

FIG. 8 shows an example of the threshold value changing table.

A threshold value changing table 801 has a first threshold value 802 and second threshold values 803, for each type of the optical disc 101.

The second threshold-values 803 are multipliers of the first threshold value.

It should be noted here that the duty ratio is a ratio of the H signals to the OFT signal in length. The duty ratio values are provided by the duty ratio calculating unit 106. As will be noted by seeing FIG. 8, the threshold value changing table 801 lacks a second threshold value for the duty ratio range from 45% to 55%. This is because for this range, which is the predetermined range as mentioned earlier, there is no need to change the first threshold value.

The first threshold value 802 for each type of optical disc is determined in advance by preparing a number of sample optical discs for each type, for example, for CD-DA, sample discs complying with the standard that the track-to-track distance is 1.6 μm, measuring the duty ratio of the OFT signal for the sample optical discs by varying the threshold value, and determining a value, with which each duty ratio value is approximately 50%, as a threshold value for each type.

The second threshold values 803 are determined by preparing a number of sample optical discs for each type not complying with the standard, generating respectively the OFT signals for the sample discs based on the first threshold value 802 for each type, classifying the obtained values of the duty ratio into the ranges “less than 10%”, “10% to less than 30%”, . . . “90% or more”, and determining a value, with which each duty ratio value is approximately 50% for each of the classified duty ratio ranges, as a second threshold value. It should be noted here that in FIG. 8, each second threshold value 803 is provided as a multiplier that is multiplied by the first threshold value 802 to obtain the second threshold value.

For example, when the duty ratio of a low-quality CD-DA is 40%, the second threshold value is set to the result value of A×0.8 (mV), which is to change the duty ratio to fall within the range from 45% to 55%.

The threshold value changing unit 107, when notified of a duty ratio from the duty ratio calculating unit 106, instructs the signal generating unit 104 to set a second threshold value 803 corresponding to the notified duty ratio.

It should be noted here that when a duty ratio within a range from 45% to 55% is notified, the instruction to change the threshold value is not issued since there is no need to change the threshold value.

The driving unit 108, which is achieved by an actuator or the like, moves the pickup 103 radially above the optical disc 101 in accordance with the tracking drive signal input from the tracking control unit 105.

It should be noted here that in the present embodiment, only components that are unique to the present invention are described, and other components such as the control unit or the output unit (not illustrated) are not described since they may be of a conventional technology.

In the present embodiment, the second threshold values are set so that the duty ratio values fall within a predetermined range. The settings are done each time an optical disc is inserted in the optical disc apparatus.

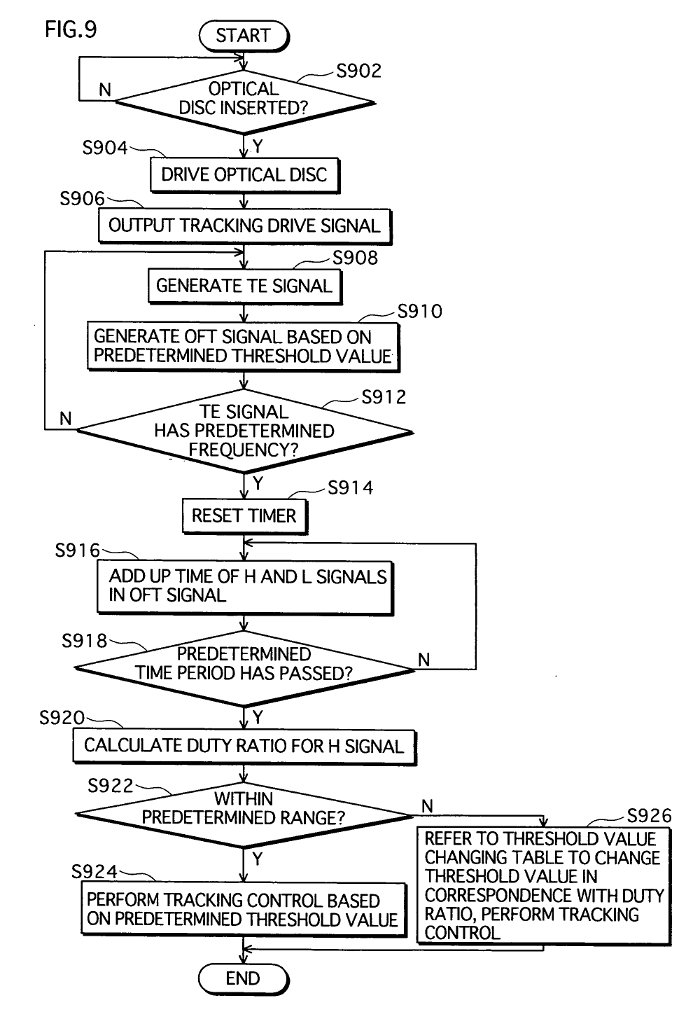

The operation of the optical disc apparatus in the present embodiment will be described with reference to FIG. 9.

The optical disc apparatus waits for the optical disc 101 to be inserted into the disc driving unit 102 (S902). After the optical disc 101 is inserted, the control unit (not illustrated) controls the disc driving unit 102 so as to rotate the optical disc 101 at a certain speed (S904).

The tracking control unit 105 receives an instruction from the control unit and according to the instruction, outputs the tracking drive signal 701 shown in FIG. 7 to the driving unit 108 (S906).

The signal generating unit 104 generates a TE signal from the two signals of the reflected/diffracted light input from the pickup 103, and outputs the generated TE signal to the tracking control unit 105 (S908).

The signal generating unit 104 converts the RF signal input from the pickup 103 into the OFT signal based on the first threshold value that is set in advance, and outputs the OFT signal to the tracking control unit 105 (S910).

The tracking control unit 105 judges whether the TE signal output from the signal generating unit 104 has a predetermined frequency, that is to say, whether the pickup 103 is crossing tracks of the optical disc 101 at a predetermined speed (S912).

The tracking control unit 105, if it is judged in step S910 that the TE signal has a predetermined frequency, outputs the input OFT signal to the duty ratio calculating unit 106.

The duty ratio calculating unit 106, after receiving the OFT signal from the tracking control unit 105, resets the timer (S914), and adds up the time periods of the H signals and L signals in the OFT signal, respectively (S916). The adding up of the time periods is performed for a predetermined time period, for example, for a time period taken for the pickup to cross 8192 tracks (S918).

The duty ratio calculating unit 106 calculates the duty ratio and notifies the calculated duty ratio to the threshold value changing unit 107 (S920).

Upon receiving the duty ratio from the duty ratio calculating unit 106, the threshold value changing unit 107 judges whether the received duty ratio falls within a predetermined range, that is to say, a range from 45% to 55% (S922).

If it is judged in step S922 that the duty ratio falls within the predetermined range, the signal generating unit 104 converts the OFT signal into a binarized signal based on the first threshold value set in advance, and the tracking control unit 105 performs the tracking control using the OFT signal and the TE signal (S924), and the process ends.

If it is judged in step S922 that the duty ratio does not fall within the predetermined range, the threshold value changing unit 107 refers to the threshold value changing table 801 to read a multiplier corresponding to the duty ratio for the type of the optical disc 101, multiplies the first threshold value by the read multiplier, and notifies the signal generating unit 104 of the multiplication result as the second threshold value, instructing the signal generating unit 104 to change the threshold value (S926).

The tracking control unit 105 performs the tracking control using the OFT signal, which was generated based on the second threshold value, and the TE signal, and the process ends.

The above-described operation enables the optical disc apparatus to reproduce or record data on/onto even a low-quality optical disc inserted therein.

In the present embodiment, it is presumed that the RF signal is output as a voltage value, and that the first threshold value is represented by mV. However, when the RF signal is output as a digital value, the first threshold value may be set to a digital value.

In the present embodiment, the threshold value changing table is used to set the second threshold values. However, the second threshold values may be determined in a different manner. For example, the second threshold values may be set as follows. The amount of change, for example, a voltage value CmV, which is observed when the threshold value changing unit 107 changes the threshold value, is stored in advance. When the notified duty ratio value is lower than the predetermined range, the second threshold value is obtained as a result value of subtracting “CmV” from the first threshold value, and the obtained second threshold value is set in the signal generating unit 104. The duty ratio calculating unit 106 calculates the duty ratio again. The threshold value changing unit 107 may repeat this process until the notified duty ratio falls within the predetermined range. In such a case, when the duty ratio exceeds the predetermined range, the second threshold value is obtained as a result value of adding “CmV” to the first threshold value, and the obtained second threshold value is set in the signal generating unit 104.

The above-described method eliminates the need to collect samples of low-quality optical discs and create and store a threshold value changing table in advance. Alternatively, the threshold value changing unit 107 may store the following equation in advance for calculation of the second threshold values:
Second threshold value=k×(Duty ratio−50)+First threshold value
where “k” represents a parameter uniquely allocated to each type of optical disc, for example, k=0.2 for CD-DA, and k=0.25 for CD-RW.

It should be noted here that in this case, the RF signal and the first threshold value are given as digital values, not as voltage values.

In the above description, the parameter “k” is uniquely allocated to each type of optical disc. However, the parameter may be changed based on how far the duty ratio is deviated from the predetermined range. In such a case, the threshold value changing unit 107 selects a value for “k” that corresponds to a duty ratio value notified from the duty ratio calculating unit 106, and calculates the second threshold value using the value “k” that has been determined in advance.

In the present embodiment, the optical disc apparatus is constructed as shown in FIG. 1. However, the functions of the components of the optical disc apparatus may be achieved as a program that causes a computer to execute the functions.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. An optical disc apparatus comprising:
a pickup operable to emit a laser beam toward an optical disc and detect a read signal from a reflected laser beam;
a driving unit operable to drive the pickup radially above the optical disc;
a tracking error signal generating unit operable to generate a tracking error signal that indicates a distance between a track in which information is recorded and a focal point of the emitted laser beam;
an offtrack signal generating unit operable to generate an offtrack signal from the detected read signal based on a threshold value, the offtrack signal being a binarized signal composed of H signals and L signals;
a threshold value changing unit operable to, when a duty ratio, which is a ratio of the H signals to the offtrack signal in length, does not fall within a predetermined range, change the threshold value from a first value to a second value so as to correct the duty ratio; and
a tracking control unit operable to control the driving unit in accordance with the tracking error signal and the offtrack signal.

2. The optical disc apparatus of claim 1, wherein
the threshold value changing unit includes:
an H signal measuring sub-unit operable to measure time of H signals of the offtrack signal for a predetermined time period, and add up the measured time;
an L signal measuring sub-unit operable to measure time of L signals of the offtrack signal for the predetermined time period, and add up the measured time; and
a duty ratio calculating sub-unit operable to calculate a duty ratio by dividing a summation time of the H signals measured in the predetermined time period by a summation time of the H signals and the L signals measured in the predetermined time period.

3. The optical disc apparatus of claim 2, wherein
the predetermined time period corresponds to a time period during which a predetermined frequency is detected in the tracking error signal.

4. The optical disc apparatus of claim 2, wherein
the threshold value changing unit further includes:
a pulse generating sub-unit operable to generate pulse signals which are each shorter than each H signal or L signal in the offtrack signal, wherein
the H signal measuring sub-unit and the L signal measuring sub-unit count the number of pulses generated by the pulse generating sub-unit for each duration of H signals and L signals, for the measuring of the time of H signals and L signals, respectively.

5. The optical disc apparatus of claim 1, wherein
the predetermined range of the duty ratio is a range from 45% to 55%, and
the first value of the threshold value is determined for each type of optical disc by preparing a predetermined number of optical discs meeting standards for each type, measuring duty ratio values of each of the optical discs based on various threshold values, selecting, among the various threshold values, a threshold value with which each of the duty ratio values is approximately 50%, and determining the selected threshold value as the first value of the threshold value.

6. The optical disc apparatus of claim 1, wherein
the threshold value changing unit includes:
a threshold value changing table storage sub-unit operable to store a threshold value changing table that indicates a plurality of second values of the threshold value corresponding to a plurality of ranges of duty ratio for each type of optical disc to which the first value of the threshold value is assigned uniquely, and
when a duty ratio value obtained based on the first value of the threshold value does not fall within the predetermined range, the threshold value changing unit changes the threshold value from the first value to a corresponding one of the plurality of second values as indicated in the threshold value changing table.

7. The optical disc apparatus of claim 1, wherein
the threshold value changing unit includes
an amount value storage sub-unit operable to store an amount value that is to be added to or subtracted from the threshold value, and
when the duty ratio is lower than the predetermined range, the threshold value changing unit subtracts the amount value from the threshold value in sequence until the duty ratio falls within the predetermined range, and when the duty ratio is higher than the predetermined range, the threshold value changing unit adds the amount value to the threshold value in sequence until the duty ratio falls within the predetermined range, and sets the second value of the threshold value to a threshold value with which the duty ratio falls within the predetermined range.

8. The optical disc apparatus of claim 1, wherein the threshold value changing unit includes:
a threshold value changing equation storage sub-unit operable to store therein an equation:
The second value of the threshold value=k×(the duty ratio−50)+the first value of the threshold value (1)
wherein “k” represents a parameter uniquely allocated to each type of optical disc, and
the threshold value changing unit calculates the second value of the threshold value in accordance with the equation (1).

9. A tracking control method for an optical disc apparatus, the tracking control method comprising the steps of:
emitting a laser beam toward an optical disc and detecting a read signal from a reflected laser beam;
driving the pickup radially above the optical disc;
generating a tracking error signal that indicates a distance between a track in which information is recorded and a focal point of the emitted laser beam;
generating an offtrack signal from the detected read signal based on a threshold value, the offtrack signal being a binarized signal composed of H signals and L signals;
changing, when a duty ratio, which is a ratio of the H signals to the offtrack signal in length, does not fall within a predetermined range, the threshold value from a first value to a second value so as to correct the duty ratio; and
controlling the driving unit in accordance with the tracking error signal and the offtrack signal.

10. A tracking control program that causes an optical disc apparatus to execute the steps of:
emitting a laser beam toward an optical disc and detecting a read signal from a reflected laser beam;
driving the pickup radially above the optical disc;
generating a tracking error signal that indicates a distance between a track in which information is recorded and a focal point of the emitted laser beam;
generating an offtrack signal from the detected read signal based on a threshold value, the offtrack signal being a binarized signal composed of H signals and L signals;
changing, when a duty ratio, which is a ratio of the H signals to the offtrack signal in length, does not fall within a predetermined range, the threshold value from a first value to a second value so as to correct the duty ratio; and
controlling the driving unit in accordance with the tracking error signal and the offtrack signal.
